(19) United States
(12) Patent Application Publication
(10) Pub. No.: US 2021/0253432 A1
(43) Pub. Date: Aug. 19, 2021

(54) ELECTROCHEMICAL GRAPHENE EXFOLIATION WITH HYDROXIDE INTERCALATION

(71) Applicant: UTI Limited Partnership, Calgary (CA)

(72) Inventors: Edward Roberts, Calgary (CA); Ashutosh Singh, Calgary (CA)

(21) Appl. No.: 17/174,552

(22) Filed: Feb. 12, 2021

Related U.S. Application Data
(60) Provisional application No. 62/976,256, filed on Feb. 13, 2020.

(51) Int. Cl. C01B 32/192; C01B 32/198

(52) U.S. Cl. CPC C01B 32/192; C01P 2004/04; C01B 32/198

(57) ABSTRACT

An electrochemically exfoliated graphene is provided, using a two step synthetic approach that involves an initial step of electrochemically intercalating hydroxides within a graphite matrix.

### FIELD

The invention is in the field of graphene chemistry.

### BACKGROUND

Graphene, with its unique 2-dimensional honeycomb structure, has attracted a significant amount of attention in electrochemistry due to its exceptional properties, such as its large aspect ratio, high surface area, superior conductivity, and catalytic activity [1]. Graphene-based materials with tunable surface chemistry have for example been suggested for use as catalysts [2], catalyst supports [3,4], and adsorption media [5,6], in applications such as fuel cells [7], sensors [8], and batteries [9]. Graphene has been synthesized by a variety of different methods, such as mechanical exfoliation of graphite [10], chemical vapor deposition (CVD) [11] reduction of graphene oxide [12] and electrochemical exfoliation of graphite [13].

Electrochemically exfoliated graphene has primarily been synthesized in three alternative electrolytes: ionic liquids [14,15], acidic aqueous media [16,17], and aqueous media containing inorganic salts [18,19, 20]. The use of inorganic salts has been reported to produce graphene with large lateral size and lower amounts of oxygen functional groups compared to other types of electrolytes [21]. Alternative approaches have been reported for synthesizing exfoliated graphene using two-step electrochemical intercalation and oxidation processes [22, 23, 24, 25]. This two-step electrochemically exfoliated graphene (EEG), is generally described as a partially oxidized graphene or graphene oxide (GO). The level of oxidation, characterized by the carbon/oxygen ratio, is typically reported to be in the range 3 to 14, which is higher than typical graphene oxide produced by chemical exfoliation methods (e.g. Hummer's method) which have been reported to have carbon/oxygen ratios of 2 to 3. The oxidizing conditions in the existing two-step exfoliation processes can lead to increasing disorder in the graphene structure, leading to a lower quality graphene product. To obtain high conductivity graphene, EEG or GO must generally be reduced by chemical or thermal processes, adding complexity and cost to the process [26].

### SUMMARY

Two-step electrochemical intercalation and oxidative graphene exfoliation processes are provided, involving hydroxide ion intercalation in the initial step. In alternative aspects of the oxidative graphene exfoliation in these processes, oxygen evolution occurs at relatively low potentials under alkaline hydroxide conditions. In this way, the exfoliation environment is less oxidizing than processes that occur at higher potentials. As a result, as demonstrated herein, a higher quality graphene may be obtained, for example in some embodiments with a carbon to oxygen ratio of around 14. In exemplified embodiments, this material has relatively high electrical conductivity—without the need for the chemical or thermal reduction processes that are characteristic of other processes for producing adequately conductive EEGs.

One general aspect includes a process for synthesizing electrochemically exfoliated graphene, including hydroxide intercalation of a graphite sample to provide a hydroxide intercalated graphite; and, exfoliation of the hydroxide intercalated graphite to provide the electrochemically exfoliated graphene. In these processes, hydroxide intercalation of the graphite sample may include applying an electrochemical intercalation current to an intercalation anode comprising the graphite sample in strongly basic aqueous intercalation electrolyte in electrical contact with an intercalation cathode. Exfoliation of the hydroxide intercalated graphite may then take place by applying an electrochemical exfoliation current to an exfoliation anode including the hydroxide intercalated graphite in an inorganic salt solution electrolyte in electrical contact with an exfoliation cathode.

Processes are accordingly provided for synthesizing an electrochemically exfoliated graphene, including: hydroxide intercalation of a graphite sample to provide a hydroxide intercalated graphite, where hydroxide intercalation includes applying an electrochemical intercalation current to an intercalation anode including the graphite sample in a basic aqueous intercalation electrolyte in electrical contact with an intercalation cathode. The process also includes electrolyte exchange, including exchanging the basic aqueous intercalation electrolyte for an inorganic or organic salt exfoliation electrolyte; and. The process also includes exfoliation of the hydroxide intercalated graphite to provide the electrochemically exfoliated graphene, where exfoliation of the hydroxide intercalated graphite includes applying an electrochemical exfoliation current to an exfoliation anode including the hydroxide intercalated graphite in the inorganic or organic salt exfoliation electrolyte in electrical contact with an exfoliation cathode.

Implementations may include one or more of the following features. The process where an electrolyte exchange potential is applied to the hydroxide intercalated graphite during at least part of the electrolyte exchange. The process where the electrolyte exchange potential is ≥1, ≥2, ≥3, ≥4, ≥5, ≥6, ≥7, ≥8, ≥9, ≥10v. The process where the basic aqueous intercalation electrolyte includes an alkali metal hydroxide and/or an alkaline earth hydroxide solution and/or hydroxides of quaternary ammonium cations or organic cations. The process where the basic aqueous intercalation electrolyte includes a potassium hydroxide and/or a sodium hydroxide solution. The process where the pH of the basic aqueous intercalation electrolyte is ≥10, ≥11, ≥12, ≥13 or ≥14. The process where the hydroxide ion concentration in the basic aqueous intercalation electrolyte is: ≥4 m, ≥5 m, ≥6 m, ≥7 m, ≥8 m, ≥9 m, ≥10 m, ≥11 m, ≥12 m, ≥13 m, ≥14 m, ≥15 m, ≥16 m, ≥17 m, ≥18 m, 19 m or 20 m; or, from about 1 m to saturation. The process where the inorganic salt exfoliation electrolyte includes one or more of ammonium sulfate (NH₄)₂SO₄, ammonium nitrate NH₄NO₃, diammonium phosphate (NH₄)₂HPO₄ and/or mono-ammonium phosphate (NH₄)H₂PO₄; optionally, wherein the concentrations of (NH₄)₂SO₄ and (NH₄)₂HPO₄ are maintained at about 0.1 M, or from 0.05 M to saturated solution. The process where the total inorganic and/or organic salt concentration in the inorganic salt exfoliation electrolyte is 0.01 m to saturated solution; or, about 0.1 m, or from 0.05 m to saturated solution. The process where the total inorganic and/or organic salt concentration in the inorganic salt exfoliation electrolyte is from 0.05 m to 5 m. The process where the intercalation cathode and/or the exfoliation cathode is stainless steel, graphite, or platinum. The process where applying the electrochemical intercalation current and/or the electrochemical exfoliation current includes fixing the distance between the electrodes and applying a constant dc voltage to the electrodes. The process where applying the electrochemical intercalation current and/or the electrochemical exfoliation current includes applying a fixed dc current density to the electrodes. The process where the fixed dc current density of the electrochemical intercalation current is from 1 to 100 mA/cm²; or from about 10 to 50 mA/cm²; or from about 20 to 40 mA/cm²; or about 30 mA/cm² of the graphite on the anode. The process where the fixed dc current density of the electrochemical exfoliation current is from 5 to 500 mA/cm²; or from about 100 to 400 mA/cm²; or from about 200 to 300 mA/cm²; or about 250 mA/cm² of the intercalated graphite on the anode. The process where applying the electrochemical intercalation current includes applying a fixed dc current density to the electrodes, and applying the electrochemical exfoliation current includes applying a fixed dc voltage to the electrodes. The process where the electrochemical exfoliation current is applied at an exfoliation cell voltage of: ≥1, ≥2, ≥3, ≥4, ≥5, ≥6, ≥7, ≥8, ≥9, ≥10v; or, 1v to 20v; or, from about 5v to 15v; or, about 10v. The process including applying the electrochemical exfoliation current to the cell until the intercalated graphite has fully exfoliated. The process where the graphite sample is a flexible graphite sheet or graphite flake.

### BRIEF DESCRIPTION OF THE DRAWINGS

FIG. 1 is a line graph illustrating the electrochemical hydroxide intercalation into graphite layers at different current densities, showing the formation of a cell potential plateau that indicates formation of hydroxide intercalated graphite. At a current density of 30 mA/cm², it takes ˜18 minutes for graphite intercalation compound formation (GIC).

FIG. 2 includes two line graphs illustrating (a) the UV-Vis spectrum of 0.04 mg/ml graphene-water suspension, showing peak at 267 nm, (b) a wavelength vs absorbance plot, showing an absorbance peak at 660 nm for different concentration of graphene-water suspensions.

FIG. 3 includes two images, showing (a) a TEM image of a graphene flake, (b) selected area electron diffraction (SAED) analysis of graphene samples.

FIG. 4 is a bar graph illustrating electrical conductivity of graphene samples reduced using different chemicals, compared with conductivity of graphene samples produced using the disclosed two-step hydroxide intercalation process.

FIG. 5 includes 3 line graphs, illustrating graphene sample florescence emission spectra at pH range of 3-10 at excitation wavelengths of (a) 250 nm, (b) 275 nm and (c) 350 nm.

FIG. 6 includes 4 panels: (a) XPS survey scan, (b) XPS Elemental analysis of graphene flakes, (c) high-resolution N1s peak deconvolution, and (d) high-resolution S2p peak deconvolution

FIG. 7 includes 2 panels: (a) Flake thickness distribution, (b) AFM thickness measurement of a single layer flake.

### DETAILED DESCRIPTION

Exemplary samples of graphenes were prepared as described in the Example below, and characterized as follows.

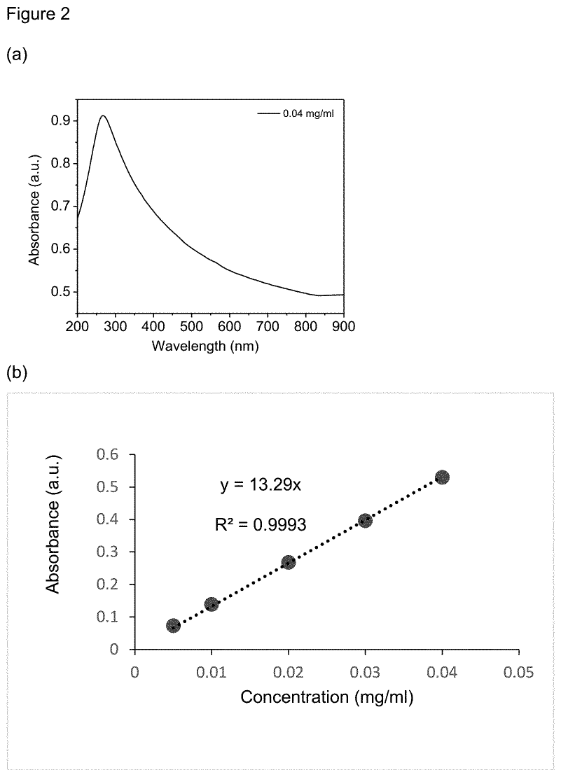

The ultraviolet-visible (UV-Vis) spectrum of graphene in water is indicative of the electronic structure of the graphene, particularly the π-electronic structure. As illustrated in FIG. 2(a), as suspension of the exemplified graphene, produced by the two-step hydroxide intercalation process, shows a characteristic peak at 267 nm. This peak is close to the corresponding peak for pristine graphene at 275 nm, and an indication of an intact graphene structure, not substantially disrupted by oxidation.

FIG. 2(a) is a UV-Vis spectrum of 0.04 mg/ml graphene in water suspension, showing the characteristic peak at 267 nm. This evidence of intact electronic structure was further confirmed by UV-Vis analysis at different concentrations of graphene in water suspension, as shown in FIG. 2(b). In that Figure, the gradient of the plot of graphene concentration vs absorbance peak was 1329 ml¹mg¹ m¹. This is much higher than a value of 49 ml¹mg¹ m¹, which was obtained using an alternative chemical exfoliation approach. The increased slope is indicative of absorbance from an intact π-electronic cloud in the graphene structure, a clear indication of less disrupted electronic structure and high-quality graphene. FIG. 2(b) accordingly illustrates the magnitude of this absorbance peak at 660 nm, plotted for different concentrations of graphene in water suspension.

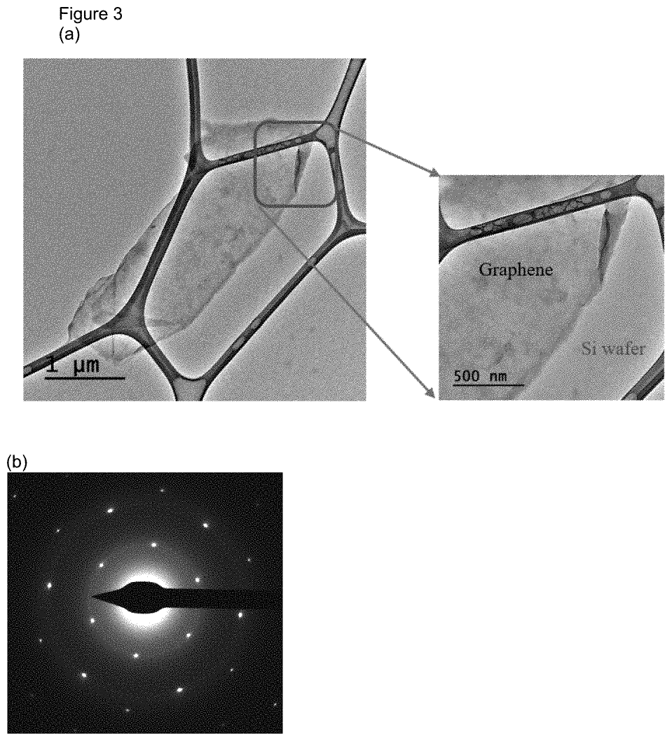

As illustrated in FIG. 3, high resolution transmission electron microscopy (HR-TEM) of the exemplified graphene shows a single monolayer coated on a silicon wafer. Selected area electron diffraction (SAED) of the graphene samples shows 6-fold symmetry with diffraction from the (0-110) and (1-210) plane, further illustrating the quality of the graphene produced using the hydroxide intercalation process.

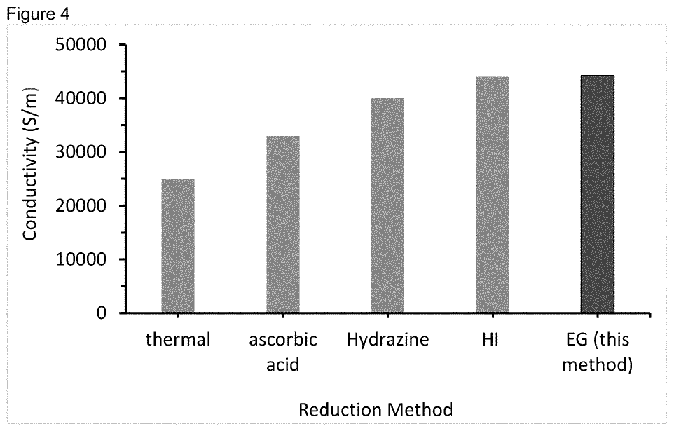

As illustrated in FIG. 4, the electronic conductivity of an exemplified graphene film was measured using a 4 probe method, and was found to be 44230 S/m. This is higher than chemically exfoliated graphene samples, which even when reduced often fail to attain comparable electrical conductivity.

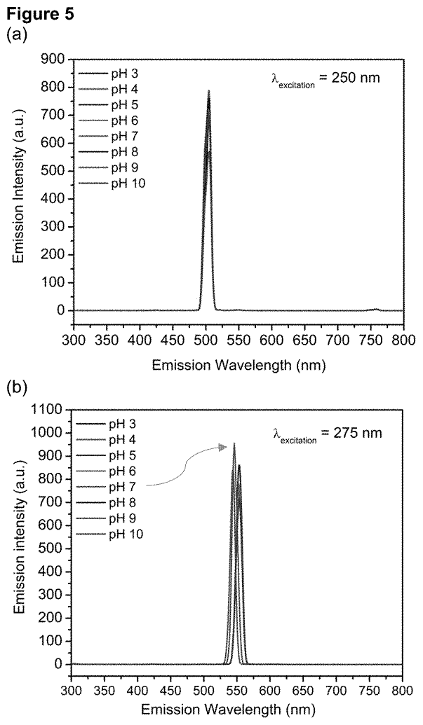

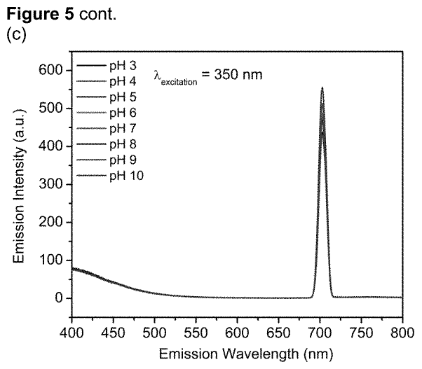

As illustrated in FIG. 5, the graphene samples produced using the exemplified hydroxide intercalation process (OH-EEG) were florescent. The exemplified graphene sample. when excited at wavelength of 250 nm (ultraviolet) was found to emit green light (λ_{Emission}=500 nm). Also, shifts in excitation wavelength to 275 nm and 350 nm resulted in shifts in emission peaks to 550 nm and 700 nm respectively. At all of the observed excitation wavelengths, the exemplified graphene samples showed pH independent florescence characteristics, i.e. they emitted green light (550 nm) at all pH values measured (at λ_{Emission}=250 nm). This illustrates a potential advantage compared to typical graphenes that are typically prepared by chemically exfoliation approach (widely known as reduced graphene oxides). Typically, chemically exfoliated graphenes need to be functionalized to enhance florescence activity [27, 28].

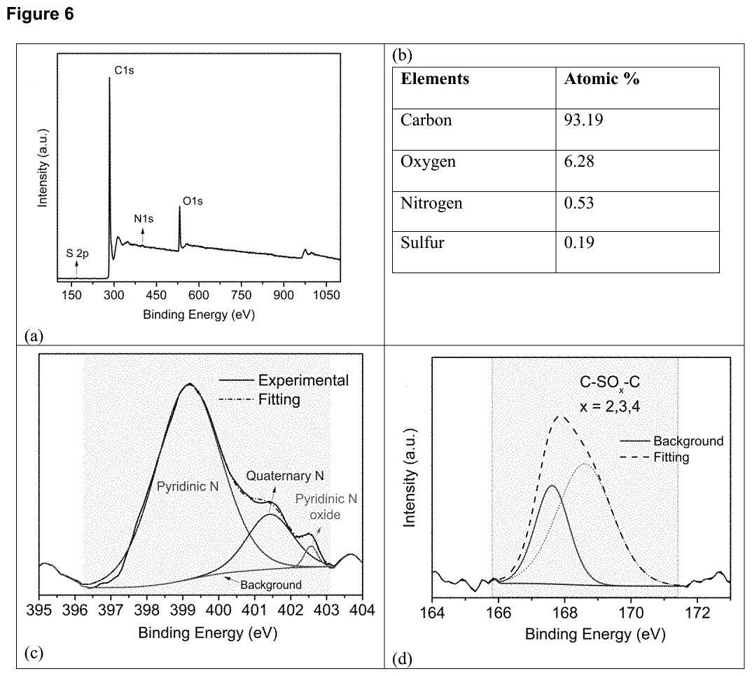

As illustrated in FIG. 6, an XPS survey scan on OH-EEG samples reveals a relatively low oxidation level with a C/O ratio of about 15, confirming relatively low oxygen functionalization during production. In practical terms, relatively low oxygen functionalization may be useful to obviate the need for conventional reduction processes that may be employed for graphene oxide reduction, processes which may give rise to toxicity and expense. Relatively small amounts of nitrogen-based functional groups (˜0.53 at %) and sulphur (0.19 at %) were found in the graphene flake by the XPS survey scan analysis of the OH-EEG samples.

As illustrated in FIG. 6, deconvolution of high-resolution Nis peak reveals a high concentration of pyridinic type nitrogen functionality followed by quaternary N and pyridinic N oxide. Pyridinic functionalities have been reported to be highly electroactive functional groups among alternative nitrogen configurations. Along with nitrogen, a small fraction of sulphur functionalization was also detected. Deconvolution of S2p peak suggests the presence of sulphur based functional groups of C-SOx-C configuration.

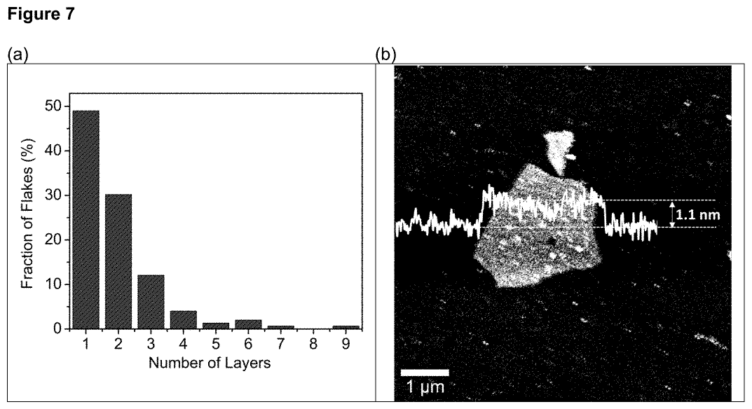

FIG. 7 illustrates results of atomic force microscopy (AFM) measurements for OH-EEG graphene flake thickness and distribution. OH-EEG flake thickness distributions are shown in FIG. 7(a). A typical flake of OH-EEG with thickness ˜1 nm is shown in FIG. 7(b), which corresponds to a monolayer. Thickness analysis of ˜150 flakes suggests ˜50% of OH-EEG flakes are monolayers (thickness<1.2 nm), ˜30% of OH-EEG flakes are bilayers (thickness ˜2 nm), ˜12% are trilayers (thickness ˜3 nm), and a small fraction ˜9% are OH-EEG flakes with thickness>4 nm.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Terms such as “exemplary” or “exemplified” are used herein to mean “serving as an example, instance, or illustration.” Any implementation described herein as “exemplary” or “exemplified” is accordingly not to be construed as necessarily preferred or advantageous over other implementations, all such implementations being independent embodiments. Unless otherwise stated, numeric ranges are inclusive of the numbers defining the range, and numbers are necessarily approximations to the given decimal. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification, and all documents cited in such documents and publications, are hereby incorporated herein by reference as if each individual publication were specifically and individually indicated to be incorporated by reference herein and as though fully set forth herein. The invention includes all embodiments and variations substantially as hereinbefore described and with reference to the examples and drawings.

### EXAMPLES

### Example 1: Electrochemical Exfoliation Procedure for Graphene Synthesis: Two Stage Process

The synthetic procedure of this Example involves two stages:

A—Intercalation of hydroxide in the graphite; and,

B—Exfoliation of the intercalated graphite.

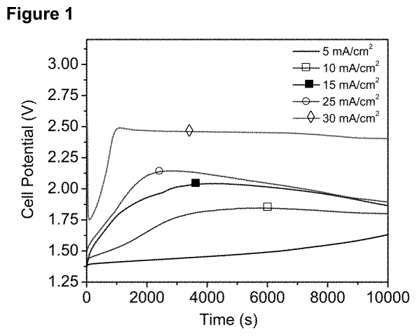

Stage A—Intercalation of Hydroxide in the Graphite:
The electrolyte used for intercalation was a 16 M solution of KOH in deionized water.
A flexible graphite foil sheet (5 cm⁻²) was used as the anode.
The cathode can be a stable metal, such as stainless steel or platinum, or graphite, in the exemplified embodiment it was platinum.
To perform the electrochemical hydroxide intercalation, a fixed DC current density was applied to the electrodes immersed in the basic aqueous intercalation electrolyte. To prepare samples for further analysis, the current density was ˜30 mA per cm² of the graphite anode.
The constant current was applied to the cell for 28 minutes. During this treatment, hydroxide ions intercalate between the graphite layers, as evidenced by expansion of the graphite foil.
FIG. 1 is a graph illustrating the progress of electrochemical hydroxide intercalation into graphite layers at different current densities, in which the formation of a cell potential plateau indicates formation of hydroxide intercalated graphite. As illustrated, at a current density of 30 mA/cm2, it takes ˜18 minutes for graphite intercalation compound formation (GIC).

Stage B—Exfoliation of the Intercalated Graphite:
In alternative embodiments, inorganic salt solutions containing ammonium sulfate, ammonium nitrate, ammonium phosphate or a mixture of these salts, were prepared at concentrations in the range 0.05 mols per liter to 3 moles per liter. To prepare graphene samples for further analysis, an ammonium sulfate solution was used at 0.1 mols/L.
After the electrochemical intercalation, the intercalation electrolyte is exchanged for an exfoliation electrolyte, and during electrolyte exchange the cell voltage was maintained. In this way, the 16 M KOH solution was removed from the cell and replaced with the inorganic salt solution.
For exfoliation, a current density of ˜250 mA cm² was applied to the cell, and this current density was maintained until all of the graphite was exfoliated and dispersed in the solution (the DC cell voltage was found to reach 10 V at this current density).
In alternative approaches, the electrochemical exfoliation may be conducted by, either:
(a) Fixing the distance between the electrodes, for example at 2 cm, and applying a constant DC voltage between the anode and cathode; or,
(b) Applying a fixed DC current density to the electrodes, for example of ˜250 mA per cm² of the graphite anode.
Exfoliation can for example be discontinued when either (a) the current drops close to 0 A (if a DC voltage is applied) or (b) the cell voltage increases significantly e.g. above 10 V (if a DC current is applied).

Post Processing
After the electrochemical exfoliation, the electrodes are removed from the beaker, and dispersed exfoliated graphene may be filtered, for example using a 0.25 μm membrane, and washed with deionized water by vacuum filtration, to obtain a filter cake.
The filter cake may then be peeled from the filter, and re-dispersed in deionized water, and sonicated and dispersed in that medium, for example using a bath sonicator for 10 minutes at 15° C.
The dispersed exfoliated graphite was then centrifuged at 2000 rpm for 10 minutes. The precipitate was re-suspended with sonication for 5 minutes between successive centrifugations.
Finally, a graphene-water dispersion was obtained for further material and electrochemical characterization

### REFERENCES

[1] X. Duan, C. Zhao, W. Liu, X. Zhao, L. Chang, Fabrication of a novel PbO2 electrode with a graphene nanosheet interlayer for electrochemical oxidation of 2-chlorophenol, Electrochim. Acta. 240 (2017) 424-436. doi:10.1016/J.ELECTACTA.2017.04.114.
[2] M. A. Betiha, A. M. Rabie, H. S. Ahmed, A. A. Abdelrahman, M. F. El-Shahat, Oxidative desulfurization using graphene and its composites for fuel containing thiophene and its derivatives: An update review, Egypt. J. Pet. (2017). doi:10.1016/J.EJPE.2017.10.006.
[3] Y. Cheng, J. Lin, K. Xu, H. Wang, X. Yao, Y. Pei, S. Yan, M. Qiao, B. Zong, Fischer-Tropsch Synthesis to Lower Olefins over Potassium-Promoted Reduced Graphene Oxide Supported Iron Catalysts, ACS Catal. 6 (2016) 389-399. doi:10.1021/acscata1.5b02024.
[4] H. Zhao, Q. Zhu, Y. Gao, P. Zhai, D. Ma, Iron oxide nanoparticles supported on pyrolytic graphene oxide as model catalysts for Fischer Tropsch synthesis, Appl. Catal. A Gen. 456 (2013) 233-239. doi:10.1016/J.APCATA.2013.03.006.
[5] Y. Gao, Y. Li, L. Zhang, H. Huang, J. Hu, S. M. Shah, X. Su, Adsorption and removal of tetracycline antibiotics from aqueous solution by graphene oxide, J. Colloid Interface Sci. 368 (2012) 540-546. doi:10.1016/J.JCIS.2011.11.015.
[6] V. Chandra, K. S. Kim, Highly selective adsorption of Hg2+ by a polypyrrole-reduced graphene oxide composite, Chem. Commun. 47 (2011) 3942-3944. doi:10.1039/C1CC00005E.
[7] R. Imran Jafri, N. Rajalakshmi, S. Ramaprabhu, Nitrogen doped graphene nanoplatelets as catalyst support for oxygen reduction reaction in proton exchange membrane fuel cell, J. Mater. Chem. 20 (2010) 7114-7117. doi:10.1039/C0JM00467G.
[8] S. Yuyan, W. Jun, W. Hong, L. Jun, A. I. A., L. Yuehe, Graphene Based Electrochemical

Sensors and Biosensors: A Review, Electroanalysis. 22 (n.d.) 1027-1036. doi:10.1002/elan.200900571.
[9] Z.-S. Wu, W. Ren, L. Wen, L. Gao, J. Zhao, Z. Chen, G. Zhou, F. Li, H.-M. Cheng, Graphene Anchored with Co3O4 Nanoparticles as Anode of Lithium Ion Batteries with Enhanced Reversible Capacity and Cyclic Performance, ACS Nano. 4 (2010) 3187-3194. doi:10.1021/nn100740x.
[10] K. S. Novoselov, A. K. Geim, S. V Morozov, D. Jiang, Y. Zhang, S. V Dubonos, I. V Grigorieva, A. A. Firsov, Electric Field Effect in Atomically Thin Carbon Films, Science (80-.). 306 (2004) 666-669. http://science.sciencemag.org/content/306/5696/666.abstract.
[11] A. Ambrosi, M. Pumera, The CVD graphene transfer procedure introduces metallic impurities which alter the graphene electrochemical properties, Nanoscale. 6 (2014) 472-476. doi:10.1039/C3NR05230C.
[12] S. Pei, H.-M. Cheng, The reduction of graphene oxide, Carbon N. Y. 50 (2012) 3210-3228. doi:10.1016/J.CARBON.2011.11.010.
[13] R. Gondosiswanto, X. Lu, C. Zhao, Preparation of Metal-Free Nitrogen-Doped Graphene Via Direct Electrochemical Exfoliation of Graphite in Ammonium Nitrate, Aust. J. Chem. 68 (2015) 830-835. https://doi.org/10.1071/CH14447.
[14] J. Lu, J. Yang, J. Wang, A. Lim, S. Wang, K. P. Loh, One-Pot Synthesis of Fluorescent Carbon Nanoribbons, Nanoparticles, and Graphene by the Exfoliation of Graphite in Ionic Liquids, ACS Nano. 3 (2009) 2367-2375. doi:10.1021/nn900546b.
[15] X. Lu, C. Zhao, Controlled electrochemical intercalation{,} exfoliation and in situ nitrogen doping of graphite in nitrate-based protic ionic liquids, Phys. Chem. Chem. Phys. 15 (2013) 20005-20009. doi:10.1039/C3CP53917B.
[16] J. Liu, C. K. Poh, D. Zhan, L. Lai, S. H. Lim, L. Wang, X. Liu, N. Gopal Sahoo, C. Li, Z. Shen, J. Lin, Improved synthesis of graphene flakes from the multiple electrochemical exfoliation of graphite rod, Nano Energy. 2 (2013) 377-386. doi:10.1016/J.NANOEN.2012.11.003.
[17] J. Liu, H. Yang, S. G. Zhen, C. K. Poh, A. Chaurasia, J. Luo, X. Wu, E. K. L. Yeow, N. G. Sahoo, J. Lin, Z. Shen, A green approach to the synthesis of high-quality graphene oxide flakes via electrochemical exfoliation of pencil core, RSC Adv. 3 (2013) 11745-11750. doi:10.1039/C3RA41366G.
[18] K. Chen, D. Xue, Preparation of colloidal graphene in quantity by electrochemical exfoliation, J. Colloid Interface Sci. 436 (2014) 41-46. doi:10.1016/J.JCIS.2014.08.057.
[19] N. Parveen, M. O. Ansari, M. H. Cho, Simple route for gram synthesis of less defective few layered graphene and its electrochemical performance, RSC Adv. 5 (2015) 44920-44927. doi:10.1039/C5RA06404J.
[20] US Patent Publication No.: US 2016/0097133.
[21] K. Parvez, Z.-S. Wu, R. Li, X. Liu, R. Graf, X. Feng, K. Mullen, Exfoliation of Graphite into Graphene in Aqueous Solutions of Inorganic Salts, J. Am. Chem. Soc. 136 (2014) 6083-6091. doi:10.1021/ja5017156.
[22] J. Cao, P. He, M. A. Mohammed, X. Zhao, R. J. Young, B. Derby, I. A. Kinloch, R. A. W. Dryfe, Two-Step Electrochemical Intercalation and Oxidation of Graphite for the Mass Production of Graphene Oxide, J. Am. Chem. Soc. 139 (2017) 17446-17456. doi:10.1021/jacs.7b08515.
[23] S. Pei, Q. Wei, K. Huang, H.-M. Cheng, W. Ren, Green synthesis of graphene oxide by seconds timescale water electrolytic oxidation, Nat. Commun. 9 (2018) 145. doi:10.1038/541467-017-02479-z.
[24] Dimiev, A. M.; Shukhina, K.; Behabtu, N.; Pasquali, M.; Tour, J. M. Stage Transitions in Graphite Intercalation Compounds: Role of the Graphite Structure. J. Phys. Chem. C 2019, 123, 19246-19253.
[25] Kovtyukhova, N. I.; Wang, Y.; Berkdemir, A.; Cruz-Silva, R.; Terrones, M.; Crespi, V. H.; Mallouk, T. E. Non-Oxidative Intercalation and Exfoliation of Graphite by Brønsted Acids. Nat. Chem. 2014, 6, 957.
[26] Raccichini, R.; Varzi, A.; Passerini, S.; Scrosati, B. The Role of Graphene for Electrochemical Energy Storage. Nat. Mater. 2014, 14, 271.
[27] Chang, D. W.; Sohn, G.-J.; Dai, L.; Baek, J.-B. Reversible Adsorption of Conjugated Amphiphilic Dendrimers onto Reduced Graphene Oxide (RGO) for Fluorescence Sensing. Soft Matter 2011, 7, 8352-8357.
[28] Gan, Z.; Xiong, S.; Wu, X.; Xu, T.; Zhu, X.; Gan, X.; Guo, J.; Shen, J.; Sun, L.; Chu, P. K. Mechanism of Photoluminescence from Chemically Derived Graphene Oxide: Role of Chemical Reduction. Adv. Opt. Mater. 2013, 1, 926-932

1. A process for synthesizing an electrochemically exfoliated graphene, comprising:
hydroxide intercalation of a graphite sample to provide a hydroxide intercalated graphite, wherein hydroxide intercalation comprises applying an electrochemical intercalation current to an intercalation anode comprising the graphite sample in a basic aqueous intercalation electrolyte in electrical contact with an intercalation cathode;
electrolyte exchange, comprising exchanging the basic aqueous intercalation electrolyte for an inorganic or organic salt exfoliation electrolyte; and,
exfoliation of the hydroxide intercalated graphite to provide the electrochemically exfoliated graphene, wherein exfoliation of the hydroxide intercalated graphite comprises applying an electrochemical exfoliation current to an exfoliation anode comprising the hydroxide intercalated graphite in the inorganic or organic salt exfoliation electrolyte in electrical contact with an exfoliation cathode.

2. The process of claim 1, wherein an electrolyte exchange potential is applied to the hydroxide intercalated graphite during at least part of the electrolyte exchange.

3. The process of claim 2, wherein the electrolyte exchange potential is ≥1, ≥2, ≥3, ≥4, ≥5, ≥6, ≥7, ≥8, ≥9, ≥10V.

4. The process of claim 1, wherein the basic aqueous intercalation electrolyte comprises an alkali metal hydroxide and/or an alkaline earth hydroxide solution and/or hydroxides of quaternary ammonium cations or organic cations.

5. The process of claim 1, wherein the basic aqueous intercalation electrolyte comprises a potassium hydroxide and/or a sodium hydroxide solution.

6. The process of claim 1, wherein the pH of the basic aqueous intercalation electrolyte is ≥10, ≥11, ≥12, ≥13 or ≥14.

7. The process of claim 1, wherein the hydroxide ion concentration in the basic aqueous intercalation electrolyte is: ≥4M, ≥5M, ≥6M, ≥7M, ≥8M, ≥9M, ≥10M, ≥11M, ≥12M, ≥13M, ≥14M, ≥15M, ≥16M, ≥17M, ≥18M, ≥19M or ≥20M; or, from about 1M to saturation.

8. The process of claim 1, wherein the inorganic salt exfoliation electrolyte comprises one or more of ammonium sulfate (NH₄)₂SO₄, ammonium nitrate NH₄NO₃, diammonium phosphate (NH₄)₂HPO₄ and/or mono-ammonium phosphate (NH₄)H₂PO₄; optionally, wherein the concentrations of (NH₄)₂SO₄ and (NH₄)₂HPO₄ are maintained at about 0.1 M, or from 0.05 M to saturated solution.

9. The process of claim 1, wherein the total inorganic and/or organic salt concentration in the inorganic salt exfoliation electrolyte is 0.01 M to saturated solution; or, about 0.1 M, or from 0.05 M to saturated solution.

10. The process of claim 1, wherein the total inorganic and/or organic salt concentration in the inorganic salt exfoliation electrolyte is from 0.05 M to 5M.

11. The process of claim 1, wherein the intercalation cathode and/or the exfoliation cathode is stainless steel, graphite, or platinum.

12. The process of claim 1, wherein applying the electrochemical intercalation current and/or the electrochemical exfoliation current comprises fixing the distance between the electrodes and applying a constant DC voltage to the electrodes.

13. The process of claim 1, wherein applying the electrochemical intercalation current and/or the electrochemical exfoliation current comprises applying a fixed DC current density to the electrodes.

14. The process of claim 13, wherein the fixed DC current density of the electrochemical intercalation current is from 1 to 100 mA/cm²; or from about 10 to 50 mA/cm²; or from about 20 to 40 mA/cm²; or about 30 mA/cm² of the graphite on the anode.

15. The process of claim 13, wherein the fixed DC current density of the electrochemical exfoliation current is from 5 to 500 mA/cm²; or from about 100 to 400 mA/cm²; or from about 200 to 300 mA/cm²; or about 250 mA/cm² of the intercalated graphite on the anode.

16. The process of claim 1, wherein applying the electrochemical intercalation current comprises applying a fixed DC current density to the electrodes, and applying the the electrochemical exfoliation current comprises applying a fixed DC voltage to the electrodes.

17. The process of claim 1, wherein the electrochemical exfoliation current is applied at an exfoliation cell voltage of: ≥1, ≥2, ≥3, ≥4, ≥5, ≥6, ≥7, ≥8, ≥9, ≥10V; or, 1V to 20V; or, from about 5V to 15V; or, about 10V.

18. The process of claim 1, comprising applying the electrochemical exfoliation current to the cell until the intercalated graphite has fully exfoliated.

19. The process of claim 1, wherein the graphite sample is a flexible graphite sheet or graphite flake.

20. A process for synthesizing an electrochemically exfoliated graphene, comprising:
hydroxide intercalation of a graphite sample to provide a hydroxide intercalated graphite, wherein hydroxide intercalation comprises applying an electrochemical intercalation current to an intercalation anode comprising the graphite sample in a basic aqueous intercalation electrolyte in electrical contact with an intercalation cathode, wherein the basic aqueous intercalation electrolyte comprises an alkali metal hydroxide and/or an alkaline earth hydroxide solution and/or hydroxides of quaternary ammonium cations or organic cations, wherein the pH of the basic aqueous intercalation electrolyte is ≥10, wherein the hydroxide ion concentration in the basic aqueous intercalation electrolyte is: ≥4M;
electrolyte exchange, comprising exchanging the basic aqueous intercalation electrolyte for an inorganic or organic salt exfoliation electrolyte, wherein an electrolyte exchange potential is applied to the hydroxide intercalated graphite during at least part of the electrolyte exchange; and,
exfoliation of the hydroxide intercalated graphite to provide the electrochemically exfoliated graphene, wherein exfoliation of the hydroxide intercalated graphite comprises applying an electrochemical exfoliation current to an exfoliation anode comprising the hydroxide intercalated graphite in the inorganic or organic salt exfoliation electrolyte in electrical contact with an exfoliation cathode, wherein the total inorganic and/or organic salt concentration in the inorganic salt exfoliation electrolyte is 0.01 M to saturated solution.
